(19) United States
(12) Patent Application Publication
(10) Pub. No.: US 2003/0216275 A1
(43) Pub. Date: Nov. 20, 2003

(54) Nª,n -dialkyl aminomethylenephosphonic acids and use thereof

(76) Inventors: Druce K Crump, Lake Jackson, TX (US); David A Wilson, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/257,825

(22) PCT Filed: Apr. 18, 2001
(86) PCT No.: PCT/US01/12660

(51) Int. Cl. C11D 3/00

(52) U.S. Cl. 510/309; 510/313; 510/376

(57) ABSTRACT

Compositions comprising at least one N^{α},N^{ω}-dialkyl aminomethylenephosphonic acid having formula (I) or N-oxide thereof having formula (II) or formula (III) wherein R is an alkylene group having from 2 to 6 carbon atoms; R₁ and R₂ are each independently an alkyl group having from 1 to 6, preferably 1 to 4, carbon atoms, a hydroxyalkyl group having alkyl of from 1 to 6, preferably 1 to 4, carbon atoms, or carboxyalkyl group having alkyl of from 1 to 6, preferably from 1 to 4, carbon atoms; M is, independently in each occurrence, selected from the group consisting of H, NH₄, amine, alkali metal, alkaline earth metal, or a linear or branched alkyl group having from 1 to 4 carbon atoms; and n is an integer from 1 to 6; are surprisingly found to have superior performance in peroxide bleaching of cellulosic materials, corrosion and scale inhibition or scale removal in water treatment and oil field applications, detergent applications, and chelation of metal ions.

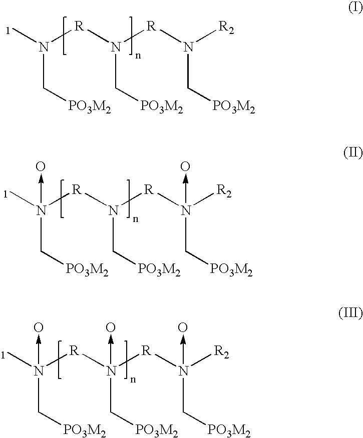

This invention relates to a composition comprising N^{α},N^{ω}-dialkyl aminomethylenephosphonic acids or N-oxides thereof and the use thereof for stabilizing peroxide in cellulosic materials bleaching, laundry cleaning and corrosion and scale deposit control applications.

Polyaminophosphonic acid compounds are known to have utility in a wide range of applications such as scale deposition prevention agents, detergent formulations, stabilizing agents in peroxygen bleaching of cellulosic materials such as textiles and wood pulp, and as metal ion control agents in a variety of other applications.

U.S. Pat. No. 3,639,645 (Miller et al) discloses scale inhibiting compositions for use in water treatment that include amino-methylenephosphonic acids and hydroxycarboxylic acids. While the generic structure of the aminomethylenephosphonic acids disclosed by Miller et al encompasses a great number of both non-N-alkylated and N-alkylated aminomethylenephosphonic acids, only experimental data for a single non-N-alkylated amino-methylenephosphonic acid, EDTMP (ethylenediamine tetramethylenephosphonic acid has been provided by Miller et al. No N-alkylated compounds were prepared or tested.

U.S. Pat. No. 3,925,245 (Harris et al) discloses a synergistic combination of aminoalkylphosphonic acid and nitrite for corrosion inhibition. Again, while the generic structure of the aminomethylenephosphonic acids disclosed by Harris et al encompasses a great number of both non-N-alkylated and N-alkylated aminomethylenephosphonic acids, only a small number of non-N-alkylated amino-methylenephosphonic acids have been made by Harris et al and experimental data provided only for these compounds. There is no data provided by Harris et al which would lead a person of ordinary skill in the art to believe that certain N-alkylated aminomethylenephosphonic acids would have different activity than the corresponding non-N-alkylated aminomethylenephosphonic acids.

U.S. Pat. No. 4,652,403 (May et al) describes detergent compositions that contain a water-insoluble aluminosilicate and an aminopoly(methylenephosphonate) component which is a mixture of ethylenediamine or diethylenetriamine phosphonic acid derivatives. Although small quantities of N-methyl structures of ethylenediamine or diethylenetriamine phosphonic acid derivatives may form during standard industrial synthesis, these N-methyl compounds are generally regarded as undesirable impurities. Also, no example or experimental data for such N-alkylated phosphonic acid derivatives is given by May et al. It should be noted that the randomly-distributed N-methyl derivatives resulting from standard industrial synthesis of ethylenediamine tetramethylenephosphonic acid (EDTMP) and diethylenetriamine pentamethylenephosphonic acid (DTPMP) do not have the dramatically effective performance shown by the N^{α},N^{ω}-dialkyl aminomethylenephosphonic acids of the present invention.

U.S. Pat. Nos. 3,483,178 (Crutchfield et al) and 3,470,243 (Crutchfield et al) describe certain N-oxide phosphonic acids and N-oxide phosphonic esters which have utility in a wide range of applications such as water-treating agents, stabilizers for peroxy compounds and corrosion inhibitors. While numerous N-oxide phosphonic acids and N-oxide phosphonic esters are embraced by the generic structure given in these two U.S. patents, none of the N-oxides of N^{α},N^{ω}-dialkyl aminomethylenephosphonic acids of the present invention are exemplified or even mentioned in either of these two U.S. patents.

It is known that partially phosphonomethylated amines are regarded as less effective than their fully phosphonomethylated counterparts in applications such as water treatment, corrosion and scale inhibition, scale removal and peroxide stabilization in pulp and paper. For example, whilst diethylenetriamine penta(methylenephosphonic acid) is very effective for stabilizing peroxide during the peroxide bleaching of pulp, diethylenetriamine tri(methylenephosphonic acid), the partially phosphonomethylated derivative of diethylenetriamine, is less effective on an equal weight basis. Thus, it is the fully phosphonomethylated diethylenetriamine that is commercially produced and widely used.

Applicants have now surprisingly discovered that the N^{α},N^{ω}-dialkyl aminomethylenephosphonic acids and their N-oxides exhibit dramatically improved performance in applications such as water treatment, corrosion and scale inhibition and removal, peroxide stabilization in peroxide bleaching of cellulosic materials such as pulp and textile, detergents, oil field scale prevention and cleaning, and other chelation and metal ion control applications.

The present invention concerns a peroxide bleaching composition comprising at least one N^{α},N^{ω}-dialkyl amino-methylenephosphonic acid having the following formula I

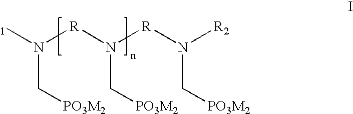

or N-oxide thereof having the following formula II or formula III

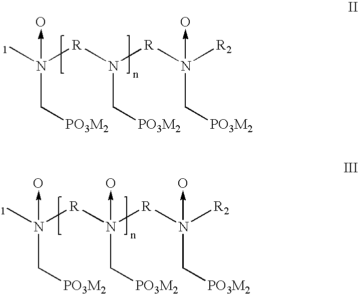

wherein R is an alkylene group having from 2 to 6, preferably 2 to 4, carbon atoms; R₁ and R₂ are each independently an alkyl group having from 1 to 6, preferably 1 to 4, carbon atoms, a hydroxyalkyl group having alkyl of from 1 to 6, preferably 1 to 4, carbon atoms, or carboxyalkyl group having alkyl of from 1 to 6, preferably from 1 to 4, carbon atoms; M is, independently in each occurrence, selected from the group consisting of H, NH₄, amine, alkali metal, alkaline earth metal, or a linear or branched alkyl group having from 1 to 4 carbon atoms; and n is an integer from 1 to 6.

In another embodiment, the present invention concerns a composition for corrosion and scale inhibition or scale removal employed in water treatment and oil field applications, said composition comprising at least one N^{α},N^{ω}-dialkyl aminomethylenephosphonic acid having the formula I hereinbefore, or N-oxide thereof having the formula II or formula III hereinbefore, wherein R, R₁, R₂, M and n are as defined hereinbefore.

Still in another embodiment, the present invention concerns a detergent composition comprising at least one N^{α},N^{ω}-dialkyl aminomethylenephosphonic acid having the formula I hereinbefore, or N-oxide thereof having the formula II or formula III hereinbefore, wherein R, R₁, R₂, M and n are as defined hereinbefore.

Yet in another embodiment, the present invention concerns a metal ion chelating composition comprising at least one N^{α},N^{ω}-dialkyl aminomethylenephosphonic acid having the formula I hereinbefore, or N-oxide thereof having the formula II or formula III hereinbefore, wherein R, R₁, R₂, M and n are as defined hereinbefore.

Still in another embodiment the present invention concerns an improved process for bleaching a cellulosic material which process comprises contacting the cellulosic material with a peroxide bleaching composition, the improvement comprising the use in the peroxide bleaching composition of at least one N^{α},N^{ω}-dialkyl aminomethylenephosphonic acid having the formula I hereinbefore, or N-oxide thereof having the formula II or formula III hereinbefore, wherein R, R₁, R₂, M and n are as defined hereinbefore, in an amount effective to stabilize a peroxide in said bleaching composition.

Yet in another embodiment, the present invention concerns an improved process for the inhibition of corrosion and scale deposits or for the removal of scale deposits in water treatment and oil field applications such as crude oil and natural gas recovery operations, the improvement comprising contacting corrosion and scale forming species or scale deposits with a composition comprising at least one N^{α},N^{ω}-dialkyl aminomethylenephosphonic acid having the formula I hereinbefore, or N-oxide thereof having the formula II or formula III hereinbefore, wherein R, R₁, R₂, M and n are as defined hereinbefore, in an amount effective to inhibit corrosion and scale deposition or remove scale deposits.

Still in another embodiment, the present invention concerns a process for chelating a metal ion which process comprises contacting a metal ion with a composition comprising at least one N^{α},N^{ω}-dialkyl aminomethylenephosphonic acid having the formula I hereinbefore, or N-oxide thereof having the formula II or formula III hereinbefore, wherein R, R₁, R₂, M and n are as defined hereinbefore, in an amount effective to chelate the metal ion.

The alkylene group having from 2 to 6 carbon atoms contemplated by R in formulas I, II and III can be a straight or branched chain alkyl group. Non-limiting examples of such alkylene groups are ethylene, n-propylene, isopropylene, n-butylene, sec-butylene, n-pentylene, and n-hexylene. Preferably, the alkylene group is ethylene, n-propylene, isopropylene, n-butylene, and sec-butylene. Most preferably, the alkylene group is such that the distance between the nitrogens is two carbons, such as ethylene, isopropylene, or the like.

The alkyl group having from 1 to 6 carbon atoms contemplated by R₁, R₂, hydroxyalkyl and carboxyalkyl in formulas I, II and III can be a straight or branched chain alkyl group. Non-limiting examples of such alkyl groups are methyl, ethyl, n-propyl, isopropyl, n-butyl, sec-butyl, n-pentyl, and n-hexyl. Preferably, the alkyl group is methyl, ethyl, n-propyl, isopropyl, n-butyl, or sec-butyl. More preferably, the alkyl group is methyl or ethyl.

The alkyl group having from 1 to 4 carbon atoms contemplated by M in formulas I, II and III can be a straight or branched chain alkyl group. Non-limiting examples of such alkyl groups are methyl, ethyl, n-propyl, isopropyl, n-butyl, and sec-butyl.

The alkali metal contemplated by M in formulas I, II and III is preferably sodium, potassium or lithium.

The alkaline earth metal contemplated by M in formulas I, II and III is preferably calcium or magnesium.

The amine contemplated by M in formulas I, II and III is preferably an ethanol or propanol amine.

M is preferably H, NH₄, sodium, potassium or calcium, more preferably H, NH₄, and sodium.

The N^{α},N^{ω}-dialkyl aminomethylenephosphonic acids of formula I hereinbefore are conveniently prepared by methods known in the art. For example, in one method tri-tosyl diethylenetriamine is first alkylated with a suitable alkylating agent (such as alkyl iodide) and then the alkylated product obtained is subsequently hydrolyzed to remove the tosyl groups in accordance with the procedure described in Inorg. Chem., Vol. 34, page 1409. N^{α},N^{ω}-dialkyl diethylenetriamine thus obtained is then phosphonomethylated by reacting it with phosphorous acid and formaldehyde using conditions known in the art to produce N^{α},N^{ω}-dialkyl aminomethylenephosphonic acids of formula I.

Th N-oxides of N^{α},N^{ω}-dialkyl aminomethylenephosphonic acids of formulas II and III hereinabove are conveniently prepared according to known procedures for oxidizing amines. In general, amine oxides are prepared by oxidizing an amine with a suitable oxidizing agent such as hydrogen peroxide. The oxidation can be carried out in aqueous solutions. See, for example, U.S. Pat. No. 3,470,243.

The N^{α},N^{ω}-dialkyl aminomethylenephosphonic acids of formula I hereinbefore and their N-oxides represented by formulas II and III hereinbefore are found surprisingly to have dramatically improved performance in water treatment applications such as corrosion and scale inhibition and scale removal; stabilization of peroxide in cellulosic materials such as pulp and textile; detergent applications; oil field applications such as corrosion and scale inhibition and scale removal in crude oil and natural gas recovery operations; and other applications such as chelation and metal ion control applications. The magnitude of improvement in performance could neither be expected nor predicted from the known prior art.

The bleaching compositions of the present invention may be used in variuos bleaching applications such as, for example, bleaching of textiles, brightening or delignification of wood pulp, stain removal, and photographic processing.

In addition to at least one N^{α},N^{ω}-dialkyl aminomethylenephosphonic acids of formula I hereinbefore and their N-oxides represented by formulas II and III hereinbefore, the bleaching composition of the present invention comprise a bleaching agent and other additives conventionally used in bleaching compositions. N^{α},N^{ω}-dialkyl aminomethylene-phosphonic acids of formula I hereinbefore and their N-oxides represented by formulas II and III hereinbefore are used in bleacing composition in an amount of from about 0.005 to about 0.5 percent by weight, based on the weight of the bleaching composition, to enhance the bleaching effect by controlling metal ions. This amount of N^{α},N^{ω}-dialkyl aminomethylene-phosphonic acids of formula I hereinbefore and their N-oxides represented by formulas II and III hereinbefore is surprisingly much smaller than the amount of the conventional phosphonic acid stabilizer products required to produce the desired peroxide bleaching stabilization results.

Nonlimiting examples of bleaching agents used in bleaching compositions include hydrogen peroxide, peracetic acid, Caro's acid, sodium perborate, and sodium percarbonate. The most commonly used peroxide bleaching agent is hydrogen peroxide.

In the bleaching of textiles, the bleach bath may be comprised of components including water, hydrogen peroxide, sodium persulfate, sodium hydroxide, wetting agent (nonionic, cationic, anionic, or zwitterionic surfactant), and bleach stabilizer ingredients. Other ingredients that may also be used include optical brighteners, magnesium salts, chelants such as aminocarboxylic acid and/or hydroxycarboxylic acid, silicates, thickening agents, viscosity controlling agents, and dispersants. The bleach bath may be combined as a wash stage, and the treatment may be performed on dyed or non-dyed fabrics. When hydrogen peroxide is employed, its composition may range from about 0.5 to 5 percent by weight in the bleach bath; sodium hydroxide may be present in a range from about 0.5 to about 10 percent by weight; wetting agent may be present from about 0.1 to about 5 percent by weight; stabilizer adjuncts such as hydroxycarboxylic acids may be present from about 0.01 to about 0.5 percent by weight; other ingredients such as brighteners, silicates, and dispersants each may typically compose less than about 5 percent by weight of the bleach bath. Water is present in the greatest amount, at up to about 95 percent by weight of the bleach bath composition. The variations and compositions among the typical textile bleaching techniques are familiar to those with normal skill in the art.

Peroxide agents are also widely employed in the bleaching of wood pulp. Hydrogen peroxide is the most widely used peroxide agent used for brightening of wood pulp. A typical peroxide bleaching stage of wood pulp may be performed under a pressure of about 5 atmospheres using ambient air or oxygen gas, as well as at ambient atmospheric pressures. Hydrogen peroxide may be used at a dose rate on Oven Dried pulp (O.D. pulp) of from about 0.1% to 10% in the peroxide bleaching stage. The wood pulp may be derived from a chemical pulp process, mechanical or groundwood pulp process, chemi-thermomechanical pulp process, or other process variation familiar to those in the art. The N^{α},N^{ω}-dialkyl aminomethylene-phosphonic acids of formula I hereinbefore and their N-oxides represented by formulas II and III hereinbefore may be used to help improve the peroxide bleaching stage by using them primarily in one or both of the following ways: (1) alone or in part with other components as a pretreatment prior to the peroxide bleaching stage to reduce the metal ion content before bleaching, or (2) alone or in part with other components in the peroxide bleaching stage to enhance brightening and achieve greater utilization of the peroxide. For the pretreatment of wood pulp to reduce the metal ion content, the N^{α},N^{ω}-dialkyl aminomethylene-phosphonic acids of formula I hereinbefore and their N-oxides represented by formulas II and III hereinbefore are used at from about 0.05 percent to about 0.5 percent on O.D. pulp. As an additive to the bleaching liquor, the N^{α},N^{ω}-dialkyl aminomethylene-phosphonic acids of formula I hereinbefore and their N-oxides represented by formulas II and III hereinbefore are used from about 0.005 percent to about 0.2 percent on O.D. pulp. The advantage of the compounds of the invention is that significantly less is needed than conventional phosphonic acid products, thus offering a cost advantage and reducing nitrogen and phosphorus in bleach plant effuents.

A pulp bleaching process may include several stages. Some of the pulp bleaching stages that may be encountered in chemical pulp processes include oxygen, chlorine dioxide, ozone, hydrogen peroxide, pressurized hydrogen peroxide, peroxymonosulfate, peracetic acid, and others. The N^{α},N^{ω}-dialkyl aminomethylene-phosphonic acids of formula I hereinbefore and their N-oxides represented by formulas II and III hereinbefore may be employed within or prior to any of these stages, while the stages that would benefit most from their use are those stages that employ hydrogen peroxide. Some of the bleaching stages that may be encountered in mechanical pulping and deinking processes include hydrosulfite, formamidinesulfinic acid, and hydrogen peroxide. Bleaching agents may be added in a bleaching tower, as a part of the refining process, or in a repulper. The use of N^{α},N^{ω}-dialkyl aminomethylene-phosphonic acids of formula I hereinbefore and their N-oxides represented by formulas II and III hereinbefore results in an improvement in all mechanical pulp and deinking pulp bleaching stages.

In peroxide bleaching of pulp, there may be other components present in addition to water, pulp, hydrogen peroxide, and stabilizer. These components may include chemicals that were added to the pulp in previous stages or those that are added with the bleach liquor. Such substances that may be added with the bleach liquor include magnesium salts, silicates, other complexing agents such as aminocarboxylic acids, hydroxycarboxylic acids, water-soluble polymers, zeolites, carbonate salts, or bleaching catalysts. Examples of some bleaching catalysts are descrbed in U.S. Pat. No. 6,136,223.

The use of N^{α},N^{ω}-dialkyl aminomethylene-phosphonic acids of formula I hereinbefore and their N-oxides represented by formulas II and III hereinbefore in detergent compositions enhances of peroxide bleaching components and facilitate the removal of various food stains from fabrics during laundering operations.

Typically, the detergent compositions of the present invention comprise from about 0.01 to about 15, preferably from about 0.05 to about 5 percent by weight of at least one N^{α},N^{ω}-dialkyl aminomethylene-phosphonic acids of formula I hereinbefore and their N-oxides represented by formulas II and III hereinbefore; from about 1 to about 80, preferably from about 10 to about 50, percent by weight of a detergent surfactant selected from nonionic, anionic, cationic, zwitterionic, and ampholytic surfactants and mixturtes thereof; and from about 5 to about 80, preferably from about 10 to about 50 percent by weight of a detergent builder.

Nonionic surfactants that are suitable for use in the present invention include those that are disclosed in U.S. Pat. No. 3,929,678. Included, without limitation, are the condensation products of ethylene oxide with aliphatic alcohols, the condensation of ethylene oxide with the base formed by the condensation of propylene oxide and propylene glycol or the product formed by the condensation of propylene oxide and ethylendiamine. Also included are the various polyethylene oxide condensates of alkyl phenols and various amine oxide surfactants.

Anionic surfactants that are suitable for use in the present invention are described in U.S. Pat. No. 3,929,678. These include, without limitation, sodium and potassium alkyl sulfates; various salts of higher fatty acids, and alkyl polyethoxylate sulfates.

Cationic surfactants that may be used are described in U.S. Pat. No. 4,228,044. Preferred cationic surfactants are the quaternary ammonium surfactants.

In addition, ampholytic and zwitterionic surfactants such as those taught in U.S. Pat. No. 3,929,678 can be used in the present invention.

Suitable builder substances are for example: wash alkalis, such as sodium carbonate and sodium silicate, or complexing agents, such as phosphates, or ion exchangers, such as zeolites, and mixtures thereof. In addition to the above mentioned builder substances, the builder component may further contain cobuilders. In modern detergents, it is the function of cobuilders to undertake some of the functions of phosphates, for example sequestration, soil antiredeposition and primary and secondary washing action.

The builder components may contain, for example water-insoluble silicates, as described for example in German Laid-Open Application DE-OS No. 2.412.837, and/or phosphates. Similarly, other phosphorus-containing organic completing agents are suitable for use as further detergent ingredients. Examples of such detergent additives include aminotrismethylenetriphosphonic acid, ethylenediaminetetramethylenephosphonic acid, diethylenetriaminopentamethylenephosphonic acid, 1-hydroxyethanc-1,1-diphosphonic acid, phosphonoacetic and phosphonopropionic acid, copolymers of vinylphosphonic acid and acrylic and/or maleic acid and also partially or completely neutralized salts thereof.

Further organic compounds which act as builders that may be present in detergent formulations are polycarboxylic acids, hydroxycarboxylic adds and aminoocarboxylic acids which are usually used in the form of their water-soluble salts.

Preferred cobuilder substances arc polymeric carboxylates. These polymeric carboxylic acids include the carboxymethyl ethers of sugars, of starch and of cellulose. Zeolites and phosphates are also useful.

Particularly important polymeric carboxylic acids are for example, the polymers of acrylic acid, maleic acid, itaconic acid, mesaconic acid, aconitic acid, methylenemalonic acid, citraconic acid and, the copolymers between the aforementioned carboxylic acids.

The cobuilders may further contain soil antiredeposition agents which keep the dirt detached from the fiber in suspension in the liquid and thus inhibit graying.

Bleaching agents that can be used are in particular hydrogen peroxide and derivatives thereof or available chlorine compounds. Of the bleaching agent compounds which provide H₂O₂ in water, sodium perborate hydrates, such as NaBO₂.H₂O₂.3H₂O and NaBO₂.H₂O₂ and percarbonates such as 2Na₂CO₃.3H₂O₂ are of particular importance. These compounds can be replaced in part or in full by other sources of active oxygen, in particular by peroxyhydrates, such as peroxyphosphonates, citrate perhydrates, urea, H₂O₂-providing peracid salts, for example, caroates, perbenzoates or peroxyphthalates or other peroxy compounds.

Aside from N^{α},N^{ω}-dialkyl aminomethylene-phosphonic acids of formula I hereinbefore and their N-oxides represented by formulas II and III hereinbefore, customary water-soluble and/or water-insoluble stabilizers for peroxy compounds can be incorporated together with the former in amounts from 0.25 to 10 percent by weight, based on the peroxy compound. Suitable water-insoluble stabilizers are magnesium silicates with MgO: SiO₂ in a•ratio of from 4:1 to 1:4, preferably from 2:1 to 1:2, in particular 1:1 in composition, usually obtained by precipitation from aqueous solutions. Other alkaline earth metals of corresponding composition can also be suitably used.

To obtain a satisfactory bleaching action even in washing at below 80° C. and in particular in the range from 60° C., to 40° C., it is advantageous to incorporate bleach activators in the detergent, advantageously in an amount from 5 to 30 percent by weight, based on the H₂O₂-providing compound.

The bleaching agents used can also be active chlorine compounds of the inorganic or organic type.

Examples of additional additives are: suitable foam regulants, such as soaps, or nonsurfactant-like foam inhibitors such as propoxylated and/or butoxylated aminotriazines. Other suitable nonsurfactant-like foam inhibitors are organic compounds, such as paraffins, aliphatic carboxylic esters; they can be used in particular in combinations of surfactants of the sulfate and/or sulfonate type with soaps for foam inhibition. The detergents may contain optical brighteners such as derivatives of diaminostilbenedisulfonic acid, 1,3-diarylpyrazolines, or products of the class of the substituted styryls, ethylenes, thiophenes, naphthalenedicarboxylic acids or derivatives thereof, stilbenes, coumarins and naphthalimides.

It is preferred that laundry detergent compositions of the present invention also contain enzymes to enhance their through-the-wash cleaning performance on a variety of soils and stains. Amylase and protease enzymes suitable for use in detergents are well known in the art and in commercially available liquid and granular detergents. Commercial detersive enzymes (preferably a mixture of amylase and protease) are typically used at levels of from about 0.001 to about 2 weight percent, and higher, in the present detergent compositions.

Detergent compositions of this invention may contain minor amounts of other commonly used materials in order to enhance the effectiveness or attractiveness of the product. Exemplary of such materials soil redeposition inhibitors, tarnish inhibitors, perfume, fluorescers, dyes or pigments, brightening agents, enzymes, water, alcohols, other builder additives, and pH adjusters, such as sodium hydroxide and potassium hydroxide. Other optional ingredients include pH regulants, soil release agents, hydrotropes and gel-control agents, freeze-thaw stabilizers, bactericides, preservatives, suds control agents, fabric softeners especially clays and mixtures of clays with various amines and quaternary ammonium compounds.

It will be apparent from the foregoing that the compositions of this invention may be formulated according to any of the various commercially desirable forms. For example, the formulations of this invention may be provided in granular form, in liquid form, in tablet form of flakes or powders.

The N^{α},N^{ω}-dialkyl aminomethylenephosphonic acids of formula I hereinbefore and their N-oxides represented by formulas II and III hereinbefore are effective for corrosion and scale control in aqueous systems at application rates of from as low as sub-part per million levels and up to about 2 percent. The effectiveness at extremely low levels for scale deposit prevention is due to their “threshold effect” at substoichiometric concentrations, that is, they are capable of keeping insoluble salts kinetically inhibited from precipitation, or on the “threshold” of precipitation. When first applied, somewhat greater dose levels of N^{α},N^{ω}-dialkyl aminomethylenephosphonic acids are required for corrosion protection in order to achieve a passive film on the metal surface. Once the passivation of the metal surface has been achieved, the dose rate can be lowered to the low ppm range in the aqueous system.

In addition to N^{α},N^{ω}-dialkyl aminomethylenephosphonic acids of formula I hereinbefore and their N-oxides represented by formulas II and III hereinbefore, the corrosion and scale inhibiting compositions of the present invention may also contain other compounds. For example, in cooling water treatment, the other components present may include other corrosion protection agents such as molybdates, chromates, zinc, tolytriazole, or benzotriazole, to name a few. Other scale and deposit prevention additives may include terpolymers, copolymers, and homopolymers of acrylic acid, maleic acid, succinic acid, epoxysuccinic acid, aspartic acid, and other suitable monomers well known to those skilled in the art. Also included may be conventional phosphonic acid compounds such as aminotrismethylenephosphonic acid, ethylenediaminetetra-methylenephosphonic acid, diethylenetriaminepentamethylenephosphonic acid, phosphonobutanetricarboxylic acid, phsophonosuccinic acid, hydroxyphosphonoacetic acid, or others. Conventional complexing agents and their water soluble salts may also be added, such as the aminocarboxylic acids, hydroxycarboxylic acids, phosphoric acid, silicic acid, and others. Biocides are also often employed in corrosion and scale treatment programs. The level of additives for corrosion and scale prevention is typically kept as low a possible to minimize cost. Thus, dose rates of the various ingredients used for corrosion and scale control are applied at rates of less than about 1000 ppm, typically at dose rates of 100 ppm or less. The corrosion and scale inhibition compounds may be added on a continuous or interval basis.

Scale and corrosion prevention agents in the oilfield may be applied as concentrated solutions as an interval treatment or applied continuously at dose rates of up to about 1000 ppm in the aqueous stream One type of interval treatment for scale prevention or scale removal in the oilfield is a squeeze treatment. For example, in a squeeze treatment, a solution of a scale prevention composition comprising at least one N^{α},N^{ω}-dialkyl aminomethylenephosphonic acids of formula I hereinbefore and their N-oxides represented by formulas II and III hereinbefore is pumped down hole and “squeezed” into the pores of the formation around the well bore. An ingredient designed to favorably deposit the scale prevention agent to the formation surfaces may be added as a part of the inhibitor squeeze treatment or as a separate squeeze treatment. The aim is to regulate the rate at which the scale prevention agent is desorbed from the formation, to achieve a scale preventing amount of the scale prevention agent in the produced fluid over an extended period of time. Agents that may be used with the N^{α},N^{ω}-dialkyl aminomethylenephosphonic acids of formula I hereinbefore and their N-oxides represented by formulas II and III hereinbefore to achieve the desired characteristics of a squeeze treatment may include salts of aluminum, iron, magnesium, copper, or others; gycol ethers, various polymers, and salts of conventional chelating agents such as aminophosphonic acids, hydroxycarboxylic acids, or aminocarboxylic acids.

The N^{α},N^{ω}-dialkyl aminomethylenephosphonic acids of formula I hereinbefore and their N-oxides represented by formulas II and III hereinbefore prevent water-formed scale deposits such as calcium carbonate, calcium sulfate, calcium oxalate, and barium sulfate. The effective dose for scale prevention may be affected by the level and nature of cations and anions present in the water system, as well as the pH and the temperature. In general, the N^{α},N^{ω}-dialkyl aminomethylenephosphonic acids of formula I hereinbefore and their N-oxides represented by formulas II and III hereinbefore are effective at temperatures up to about 300° C., and pH range from about 3 to 14. The N^{α},N^{ω}-dialkyl aminomethylenephosphonic acids of formula I hereinbefore and their N-oxides represented by formulas II and III hereinbefore have the ability to control metal ions very effectively at elevated pH, where standard aminocarboxylic acids may fail to function effectively.

The N^{α},N^{ω}-dialkyl aminomethylenephosphonic acids of formula I hereinbefore and their N-oxides represented by formulas II and III hereinbefore are effective as chelants for metal ions. Typically, effectiveness as a chelant is conveniently measured by complexing the chelant with a metal ion such as by mixing an aqueous solution of known concentration of the chelant with an aqueous solution containing metal ions of known concentration and measuring chelation capacity by titrating the chelant with a metal ion in the presence of an indicator dye, using as an endpoint detector a photosensitive electrode.

The following examples are provided to more fully illustrate the present invention but are not intended to be, nor should they be construed as being, limiting in any way of the scope of the invention.

General Experimental

Compounds used for evaluation and performance testing were obtained from commercial sources or were synthesized in the laboratory. The following compounds listed in Table 1 were among those evaluated.

TABLE 1

| | Abbrevia- | | Comparative |
|---|---|---|---|
| Compound | tion used | Source for testing | or Invention |
| N,N″-dimethyl- | s-Me₂DTTP | Synthesized N,N″- | Invention |
| diethylenetriamine | | dimethyl- | |
| N,N′,N″- | | diethylenetriamine | |
| tri(methylene- | | then phsophono- | |
| phosphonic acid) | | methylated using | |
| | | commercial technique | |
| N,N″-diethyl- | s-Et₂DTTP | Synthesized N,N″- | Invention |
| diethylenetriamine- | | diethyl- | |
| N,N′,N″- | | diethylenetriamine | |
| tri(methylene | | then phosphono- | |
| phosphonic acid) | | methylated using | |
| | | commercial technique | |
| N,N′′′-dimethyl- | s-Me₂TTTP | Synthesized N,N′′′- | Invention |
| triethylenetetra- | | dimethyl- | |
| amine-N,N′,N″,N′′′- | | triethylenetetra- | |
| tetra(methylene- | | amine, and | |
| phosphonic acid) | | phosphonomethyl-ated | |
| | | using commercial | |
| | | technique | |
| N,N″-dimethyl- | s-Me₂DTTP | Synthesized from s- | Invention |
| diethylenetriamine | N-oxide | Me₂DTTP by reaction | |
| N,N′,N″- | | with hydrogen | |
| tri (methylene- | | peroxide | |
| phosphonic acid)- | | | |
| N,N′,N″-tris(N- | | | |
| oxide) | | | |
| Diethylenetriaminepe | DTPMP | Commercially | Comparative |
| nta(methylene- | | available (Dequest | |
| phosphonic acid) | | 2066) | |
| Ethylenediamine- | EDTMP | Commercially | Comparative |
| tetra(methylene- | | available (Dequest | |
| phosphonic acid) | | 2041) | |
| Hexamethylene- | HMDTMP | Commercially | Comparative |
| diamine- | | available (Dequest | |
| tetra(methylene- | | 2051) | |
| phosphonic acid) | | | |
| Aminotri(methyleneph | AMP | Commercially | Comparative |
| osphonic acid) | | available (Dequest | |
| | | 2010) | |
| Proprietary | Dequest | Commercially | Comparative |
| aminophosphonic acid | 2086 | available from | |
| | | Solutia | |
| Monoethanolamine- | MEA-phos | Commercially | Comparative |
| di(phosphonic acid) | | available (Wayplex | |
| | | 61-A) | |
| Phosphonosuccinate | Bricorr | Commercially | Comparative |
| | 288 | available from | |
| | | Albright & Wilson | |
| Hydroxyethylidene | HEDP | Commercially | Comparative |
| di(phosphonic acid) | | available (Mayoquest | |
| | | 1500) | |
| Phosphonobutane | PBTCA | Commercially | Comparative |
| tricarboxylate | | available (Mayoquest | |
| | | 2100) | |
| Triethylenetetra | TTHMPA | Synthesized from | Comparative |
| amine | | linear | |
| hexa(methylene- | | triethylenetetra- | |
| phosphonic acid) | | amine using | |
| | | commercial | |
| | | techniques | |
| Dipropylenetri-amine | DPTPMP | Synthesized from N- | Comparative |
| penta(methylene- | | (3-aminoproyl)-1,3- | |
| phosphonic acid) | | propanediamine using | |
| | | commercial technique | |
| Monomethylamine | MMA-phos | Synthesized from | Comparative |
| di(phosphonic acid) | | monomethylamine | |
| | | using commercial | |
| | | technique | |
| Ethylenediaminebis(p | EDA-BP- | Synthesized from N, | Comparative |
| ropylamine) | phos | N′-bis(3- | |
| hexa(methylene- | | aminopropyl)- | |
| phosphonic acid) | | ethylenediamine | |
| | | using commercial | |
| | | technique | |
| N,N-dimethyl- | u-Me₂EDDP | Synthesized from | Comparative |
| ethylenediaminebis(m | | N,N-dimethyl- | |
| ethylene-phosphonic | | ethylenediainine | |
| acid) | | using commercial | |
| | | technique | |
| N,N-dimethyl- | u-Me₂DTTP | Synthesized from | Comparative |
| diethylenetriaminetr | | N,N-dimethyl- | |
| i(methylenephosphoni | | diethylenetriamine | |
| c acid) | | using commercial | |
| | | technique | |
| N,N′-dimethyl- | s-Me₂EDDP | Synthesized from | Comparative |
| ethylenediamine | | N,N′-dimethyl- | |
| | | ethylenediamine | |
| | | using commercial | |
| | | technique | |
| Silicate | Silicate | Commercially | Comparative |
| | | available, such as | |
| | | PQ-N available from | |
| | | Philadelphia Quartz | |

Preparation of s-Me₂DTTP (Invention)

N,N″-dimethyl diethylenetriamine N,N′,N″-tri(methylenephosphonic acid) was prepared by first preparing the tri-tosyl derivative of diethylenetriamine (Ts₃dien). The Ts₃dien was then alkylated on the terminal nitrogen atoms using methyl iodide to prepare N,N″-dimethyl diethylenetriamine Me₂Ts₃dien. Me₂Ts₃dien) was then hydrolyzed via HBr—HOAc to remove the tosyl groups and yield N,N″-dimethyldiethylenetriamine (Me₂dien). The synthesis technique used as a guide is described in Inorg. Chem ., Vol. 34, page 1409.

The N,N″-dimethyldiethylenetriamine was then phosphonomethylated by reacting it with phosphorous acid and formaldehyde using conditions known in the art. The aqueous product solution produced in this manner had an organic purity of greater than 95 percent N,N″-dimethyl diethylenetriamine N,N′,N″-tri(methylenephosphonic acid) (s-Me₂DTTP) .

The s-Me₂DTTP in acidic D₂O solution showed singlet peaks in the ³¹P NMR spectrum at 8.39 ppm and 11.72 ppm, representing the P atom of the two terminal N phosphonic acid groups and P atom on the center N phosphonic acid group respectively. The peaks integrated in a 2:1 ratio, in agreement with the theoretical structure. The 31P spectrum of the product solution also showed a small peak at 4.97 ppm representing a small amount of residual H₃PO₃ starting material and a very small peak at 22.34 ppm representing a trace amount of hydroxymethylenephosphonic acid (reaction product of formaldehyde and H₃PO₃). Organic purity of the product from the phosphorous NMR is greater than 95 percent as s-Me₂DTTP.

The 1H NMR spectrum in acidic D₂O showed a group of peaks representing the protons of the amine backbone and the phosphonomethyl methylenes from about 2.8 ppm to 3.3 ppm. A sharp singlet at 2.55 ppm represents the terminal N-methyl protons. Integration of the backbone and phosphonomethyl methylene protons and the N-methyl protons showed the predicted ratio of 14 to 6. There were very small peaks at 4.25 and 7.73 ppm representing the split signal from the residual H₃PO₃ raw material P-bonded proton. Purity based on the proton NMR is greater than 95 percent as s-Me₂DTTP.

The ¹³C NMR also supports the preparation of an essentially pure N,N″-dimethyldiethylenetriamine-N,N′,N″-tri(methylenephosphonic acid). The activity of the aqueous product solution was verified by titration, nitrogen analysis, and NMR techniques to be 34.4 percent active as essentially pure N,N″-dimethyldiethylene-triamine-N,N′N″-tri(methylenephosphonic acid). The s-Me₂DTTP thus produced was used in the subsequent examples of the invention.

Preparation of s-Et₂DTTP (Invention)

N,N″-diethyldiethylenetriamine-N,N′,N″-tri(methylenephosphonic acid) was prepared using the above procedure, except that ethyl iodide was used as the N-alkylating agent instead of methyl iodide. The desired phosphonic acid structure was verified by 31P NMR, 1H NMR, and 13CNMR spectra.

Preparation of s-Me₂TTTP (Invention)

N,N′″-dimethyl-triethylenetetra-amine-N,N′,N″,N′″-tetra(methylene-phosphonic acid) was prepared using the procedure outlined for synthesis of Compound 1 except that the tetra-tosyl derivative of linear triethylenetetraamine was prepared as the initial synthetic step. The desired phosphonic acid structure was verified by 31P NMR, 1H NMR, and 13CNMR spectra.

Preparation of s-Me₂DTTP N-Oxide (Invention)

N,N″-dimethyldiethylenetriamine N,N′,N″-tri(methylenephosphonic acid) tris(N-oxide) was prepared by taking the a portion of the 34.4 percent active solution of s-Me₂DTTP (preparation described above) and removing the bulk of the water and free acid by rotary evaporation. After the first evaporation, the glassy solid was re-dissolved in water and the water evaporated once again. The resulting light yellow glassy solid was dissolved using water and NaOH to provide a solution with a pH of about 10 and a solids content of about 40 percent. About 2 grams of this pH 10 solution of s-Me₂DTTP was added to about 50 grams of 30 percent hydrogen peroxide and stirred at 35° C. for 48 hours. Next, the water and peroxide was removed by rotary evaporation under controlled vacuum at 50° C. The white solid was washed with methanol and dried. The identity of the material was verified by NMR and titration to be essentially N,N″-dimethyldiethylenetriamine N,N′,N″-tri(methylene-phosphonic acid) tris(N-oxide).

Comparative compounds DTPMP, EDTMP, HMDTMP, AMP, Dequest 2086, MEA-phos, Bricorr 288, HEDP, and PBTCA were obtained from their respective commercial sources and were used according to the manufacturer's claimed percent actives content. Of these commercially available compounds, DTPMP is generally regarded as one of the most effective peroxide stabilizing additives known. Among the currently available materials, DTPMP is particularly effective alone or in combination with other components in peroxide use in textile, detergent, and pulp bleaching.

Comparative compounds TTHMPA, DPTPMP, MMA-phos, EDA-BP-phos, u-Me₂EDDP, u-Me₂DTTP, and s-Me₂EDDP were synthesized from commercially obtained amines (Aldrich Chemical Co.) and their respective phosphonic acid derivatives were prepared by reacting the amine with phosphorous acid and formaldehyde using conditions known in the art. Each was fully phosphonomethylated based on the available amino hydrogens of the amine molecule.

Comparative compound Silicate is commercially available PQ-N silicate solution. Silicate is often used as a peroxide stabilizer in various applications such as peroxide use in textile, detergents, and pulp and paper operations.

### EXAMPLE 1

A chemi-thermomechanical pulp from a southeastern Canadian pulp mill was diluted to a consistency (based on O.D. pulp; O.D.=Oven-Dried) of 4 percent. The pulp slurry was then treated with a 39 percent active Na₄EDTA aqueous solution (sold by The Dow Chemical Company under the trademark VERSENE 100 chelating agent) at a dosage of 0.5 percent based on the O.D. weight of pulp at 65° C. for one hour. After the ethylenediamine tetraacetic acid (EDTA) pretreatment, the pulp was pressed to a consistency of about 25 percent, with the filtrate being saved for use as dilution water in a later step. The pulp was then divided into 8 equal portions, each portion weighed into a plastic bag for bleaching with different bleach stabilizer systems. Respective bleaching steps were then performed as follows:

For bags number 1-4, bleach liquor was prepared in a separate bottle. Sufficient amount of a 28 percent active (expressed as acid) diethylenetriamine-pentamethylenephosphonic acid (DTPMP) solution, one of the most efficient organic stabilizers known for the stabilization of peroxide, was added to achieve 0.05 percent DTPMP solution on O.D. pulp in bottle 1, 0.1 percent DTPMP solution on O.D. pulp in bottle 2, 0.25 percent DTPMP solution on O.D. pulp in bottle 3, and 0.35 percent DTPMP solution on O.D. pulp in bottle 4. To each bottle, measured amounts of NaOH and hydrogen peroxide solutions were added to achieve 2.0 percent caustic and 2.0 percent peroxide (based on O.D. pulp) in each bottle. Immediately upon adding the peroxide portion of the bleach liquor and mixing the liquid, the bleach liquor was added to the pulp in each of the four bags and the contents of each bag mixed thoroughly by kneading for 2 minutes. The filtrate from the EDTA pretreatment step was added to achieve a targeted pulp consistency of 12 percent and then the contents were mixed thoroughly for 4 minutes. Immediately following the 4-minute mixing of the pulp and liquids, the bag was sealed with minimum entrapped air and transferred to a 65° C. water bath for 1 hour. After the 1-hour bleaching interval, the pulp mixture was removed from the bath and promptly pressed to about 25 percent consistency. The pulp pad was weighed and its exact consistency was determined. Based on the calculated consistency, the equivalent of 3 O.D. grams of the pulp pad was then used to form a handsheet according to TAPPI Test Method T 272. The handsheet reflectance was then measured using an ISO brightness meter.

For bags number 5-8, the above procedure was repeated except that a 28 percent active solution of N,N″-dimethyl diethylenetriamine N,N′,N″-tri(methylenephosphonic acid) (s-Me₂DTTP) was used instead of diethylenetriamine penta(methylenephosphonic acid) (DTPMP) as the peroxide stabilizer. The 28 percent active solution of s-Me₂DTTP was prepared from the 34.4 percent s-Me₂DTTP solution described above.

Handsheet reflectance results are shown in Table 2 below, with Delta ISO Brightness representing the difference between the bleached handsheet versus the brightness of an unbleached handsheet:

TABLE 2

| | | | Delta ISO |
|---|---|---|---|
| Bag Number | % DTPMP | % s-Me₂DTTP | Brightness |
| 1* | 0.05 | none | 10.1 |
| 2* | 0.1 | none | 10.6 |
| 3* | 0.25 | none | 12.6 |
| 4* | 0.35 | none | 12.8 |
| 5 | none | 0.05 | 12.5 |
| 6 | none | 0.1 | 13.41 |
| 7 | none | 0.25 | 13.51 |
| 8 | none | 0.35 | 13.59 |

*Comparative examples not an example of the present invention.

The above results clearly demonstrate the surprisingly superior performance of the N^{α},N^{ω}-dialkyl aminomethylenephosphonic acids of the present invention for use in peroxide bleaching of pulp. It is evident from this data that s-Me₂DTTP is up to 5 times as effective as DTPMP, and the use of s-Me₂DTTP allows for greater brightness to be achieved than is possible with DTPMP. Similar results are obtained with other mechanical pulps, recycled pulps, and chemical pulps, particularly in TCF (totally chlorine free) and ECF (elemental chlorine free) bleaching sequences that employ peroxygen bleaching systems. The s-Me₂DTTP is typically about 2 to 5 times as effective as DTPMP. The greater efficiency means less N and P is added to the bleaching process.

### EXAMPLE 2

A mechanical pulp from a Northwestern U.S. paper mill was diluted to a consistency (based on O.D.) of 4 percent. The pulp slurry was then treated with a 39 percent active Na₄EDTA aqueous solution (sold by The Dow Chemical Company under the trademark VERSENE 100 chelating agent) at a dosage of 0.5 percent based on the O.D. weight of the pulp at 65° C. for one hour. After the EDTA pretreatment, the pulp was pressed to a consistency of about 25 percent, with the filtrate being saved for use as dilution water in a later step. The pulp was then devided into 8 equal portions, each portion weighed into a plastic bag for bleaching with different bleach stabilizer systems. Respective bleaching steps were then performed as follows:

For bags number 1-4, respective bleach liquors were prepared in a separate bottles. Sufficient amount of 28 percent active diethylenetriaminepentamethylene-phosphonic acid (DTPMP) solution was added to achieve 0.1 percent DTPMP solution on O.D. pulp in bottles 1 and 2, and 0.25 percent DTPMP solution on O.D. pulp in bottles 3 and 4. To each bottle, measured amounts of NaOH and hydrogen peroxide solutions were added to achieve 2.0 percent caustic and 2.0 percent peroxide (based on O.D. pulp) in each bottle. Immediately upon adding the peroxide portion of the bleach liquor and mixing the liquid, the bleach liquor was added to the pulp in each of the four bags and the contents of each bag mixed thoroughly by kneading for 2 minutes. The filtrate from the EDTA pretreatment step was added to achieve a targeted pulp consistency of 12 percent and then the contents were mixed thoroughly for 4 minutes. Immediately following the 4-minute mixing of the pulp and liquids, the bag was sealed with minimum entrapped air and transferred to a 65° C. water bath for 1 hour. After the 1-hour bleaching interval, the pulp mixture was removed from the bath and a small portion of the bleach liquor was extracted for analysis of residual peroxide via starch-iodine thiosulfate titration. The remaining pulp and liquor mixture was promptly pressed to about 25 percent consistency. The pulp pad was weighed and its exact consistency was determined. Based on the calculated consistency, the equivalent of 3 O.D. grams of the pulp pad was then used to form a handsheet according to TAPPI Test Method T 272. The handsheet reflectance was then measured using an ISO brightness meter.

For bags number 5-8, the above procedure was repeated except that a 28 percent active solution of N,N″-dimethyl diethylenetriamine N,N′,N″-tri(methylenephosphonic acid) (s-Me₂DTTP) was used instead of diethylenetriamine penta(methylenephosphonic acid) (DTPMP) as the peroxide stabilizer.

Handsheet reflectance results are shown in Table 3 below, with Delta ISO Brightness representing the difference between the bleached handsheet versus the brightness of an unbleached handsheet:

TABLE 3

| | | | | | | % |
|---|---|---|---|---|---|---|
| | | % s- | | % | Average | Average |
| Bag | | Me₂- | Delta ISO | Residual | Delta ISO | Residual |
| Number | % DTPMP | DTTP | Brightness | Peroxide | Brightness | Peroxide |
| 1* | 0.1 | none | 8.3 | 9 | 8.3 | 8 |
| 2* | 0.1 | none | 8.33 | 7 | 8.3 | 8 |
| 3* | 0.25 | none | 10.88 | 15 | 10.77 | 14.5 |
| 4* | 0.25 | none | 10.66 | 14 | 10.77 | 14.5 |
| 5 | none | 0.1 | 11.72 | 24 | 11.77 | 23 |
| 6 | none | 0.1 | 11.81 | 22 | 11.77 | 23 |
| 7 | none | 0.25 | 12.81 | 36 | 12.82 | 36 |
| 8 | none | 0.25 | 12.83 | 36 | 12.82 | 36 |

*Comparative examples not an example of the present invention.

The above results again demonstrate that N^{α},N^{ω}-dialkyl aminophosphonic acids of the present invention have unexpected and dramatically improved performance compared to the commercially available DTPMP product in peroxide bleaching of pulp. The essentially pure s-Me₂DTTP shows more than 2.5 times effectiveness over DTPMP from a delta brightness performance standpoint, and about 2.5 to 3 times more peroxide stabilization performance over DTPMP from a residual peroxide standpoint.

### EXAMPLE 3

A thermomechanical pulp from a Southern U.S. paper mill was diluted to a consistency (based on O.D. pulp) of 4 percent. The pulp slurry was then treated with a 39 percent active Na₄EDTA aqueous solution (sold by The Dow Chemical Company under the trademark VERSENE 100 chelating agent) at a dosage of 0.5 percent based on the O.D. weight of the pulp at 65° C. for one hour. After the EDTA pretreatment, the pulp was pressed to a consistency of about 25 percent, with the filtrate being saved for use as dilution water in a later step. The pulp was then divided into 8 equal portions, each portion weighed into a plastic bag for bleaching with different bleach stabilizer systems. Respective bleaching steps were then performed as follows:

For bags number 1-4, bleach liquor was prepared in a separate bottle. Sufficient amount of 28 percent active diethylenetriaminepentamethylenephosphonic acid (DTPMP) solution was added to achieve 0.1 percent DTPMP solution on O.D. pulp in bottles 1 and 2, and 0.25 percent DTPMP solution on O.D. pulp in bottles 3 and 4. To each bottle, measured amounts of NaOH and hydrogen peroxide solutions were added to achieve 2.0 percent caustic and 2.0 percent peroxide (based on O.D. pulp) in each bottle. Immediately upon adding the peroxide portion of the bleach liquor and mixing the liquid, the bleach liquor was added to the pulp in each of the four bags and the contents of each bag mixed thoroughly by kneading for 2 minutes. The filtrate from the EDTA pretreatment step was added to achieve a targeted pulp consistency of 12 percent and then the contents were mixed thoroughly for 4 minutes. Immediately following the 4-minute mixing of the pulp and liquids, the bag was sealed with minimum entrapped air and transferred to a 65° C. water bath for 1 hour. After the 1-hour bleaching interval, the pulp mixture was removed from the bath and a small portion of the bleach liquor was extracted for analysis of residual peroxide via starch-iodine thiosulfate titration. The remaining pulp and liquor mixture was promptly pressed to about 25 percent consistency. The pulp pad was weighed and its exact consistency was determined. Based on the calculated consistency, the equivalent of 3 O.D. grams of the pulp pad was then used to form a handsheet according to TAPPI Test Method T 272. The handsheet reflectance was then measured using an ISO brightness meter.

For bags number 5-8, the above procedure was repeated except that a 28 percent active solution of N,N″-dimethyl diethylenetriamine N,N′,N″-tri(methylenephosphonic acid) (s-Me₂DTTP) was used instead of diethylenetriamine penta(methylenephosphonic acid) (DTPMP) as the peroxide stabilizer.

Handsheet reflectance results are shown in Table 4 below, with Delta ISO Brightness representing the difference between the bleached handsheet versus the brightness of an unbleached handsheet:

TABLE 4

| | | | | | | % |
|---|---|---|---|---|---|---|
| | | % S- | | % | Average | Average |
| Bag | | Me₂- | Delta ISO | Residual | Delta ISO | Residual |
| Number | % DTPMP | DTTP | Brightness | Peroxide | Brightness | Peroxide |
| 1* | 0.1 | none | 11.59 | 16 | 11.5 | 16 |
| 2* | 0.1 | none | 11.42 | 16 | 11.5 | 16 |
| 3* | 0.25 | none | 12.61 | 22 | 12.66 | 23 |
| 4* | 0.25 | none | 12.71 | 24 | 12.66 | 23 |
| 5 | none | 0.1 | 13.71 | 31 | 13.75 | 32 |
| 6 | none | 0.1 | 13.78 | 33 | 13.75 | 32 |
| 7 | none | 0.25 | 13.79 | 38 | 13.84 | 37.5 |
| 8 | none | 0.25 | 13.88 | 37 | 13.84 | 37.5 |

*Comparative examples not an example of the present invention.

The above results again demonstrate that N^{α},N^{ω}-dialkyl aminophosphonic acids of the present invention have unexpected and dramatically improved performance compared to the commercially available DTPMP product in peroxide bleaching of pulp. The essentially pure s-Me₂DTTP shows more than 2.5 times effectiveness over DTPMP from a delta brightness performance standpoint, providing a whole point of ISO brightness improvement versus 2.5 times as much DTPMP under the same conditions. s-Me₂DTTP also provided about 2 times greater peroxide stabilization performance over DTPMP from a residual peroxide standpoint.

### EXAMPLE 4

In the following experiments, a southern US thermomechanical pulp is bleached with hydrogen peroxide as described in the examples above, except that there was no pretreatment with EDTA. The lack of pretreatment to remove metals creates more demand on the bleach stabilizer. In each bleaching experiment, the peroxide is 2% on OD pulp, and the NaOH is 1.6% on OD pulp. The bleaching temperature is 1 hour at 65° C., and bleach consistency is 12% OD pulp. The additive dose on O.D. pulp is expressed as actives in the acid form, so all stabilizer compounds are compared on an equal active weight basis. Results are shown in Table 5.

TABLE 5

| | | | Delta | % of original |
|---|---|---|---|---|
| | | Dose on | Brightness | peroxide charge |
| Invention/Comparative | Abbrev. | OD pulp | (ISO) | remaining |
| Invention | s-Me₂DTTP | 0.15 | 11.46 | 35.3 |
| Invention | ″ | 0.10 | 10.96 | 33.7 |
| Invention | ″ | 0.05 | 10.44 | 17.0 |
| Invention | s-Et₂DTTP | 0.10 | 10.0 | 20.7 |
| Invention | s-Me₂TTTP | 0.15 | 11.56 | 28.4 |
| Invention | ″ | 0.10 | 9.14 | 17.1 |
| Invention | ″ | 0.05 | 8.95 | 9.8 |
| Invention | s-Me₂DTTP | 0.10 | 11.56 | 34.1 |
| | N-oxide | | | |
| Comparative | DTPMP | 0.15 | 9.83 | 22.6 |
| Comparative | ″ | 0.10 | 8.56 | 12.3 |
| Comparative | ″ | 0.05 | 5.57 | 3.4 |
| Comparative | EDTMP | 0.15 | 8.1 | 6.4 |
| Comparative | ″ | 0.05 | 5.04 | 1.3 |
| Comparative | HMDTMP | 0.15 | 4.72 | 1.2 |
| Comparative | AMP | 0.15 | 5.39 | 2.4 |
| Comparative | Dequest | 0.15 | 6.89 | 1.2 |
| | 2086 | | | |
| Comparative | Dequest | 0.05 | 3.7 | 1.5 |
| | 2086 | | | |
| Comparative | MEA-Phos | 0.15 | 3.61 | 1.0 |
| Comparative | Bricorr | 0.15 | 3.11 | 1.4 |
| | 288 | | | |
| Comparative | HEDP | 0.15 | 5.78 | 2.6 |
| Comparative | PBTCA | 0.15 | 3.08 | 0.8 |
| Comparative | TTHMPA | 0.15 | 8.7 | 18.5 |
| Comparative | DPTPMP | 0.15 | 6.3 | 3.8 |
| Comparative | MMA-Phos | 0.15 | 4.84 | 2.4 |
| Comparative | EDA-BP- | 0.15 | 7.42 | 5.6 |
| | Phos | | | |
| Comparative | u-Me₂EDDP | 0.15 | 4.36 | 1.9 |
| Comparative | ″ | 0.05 | 4.34 | 1.3 |
| Comparative | u-Me₂DTTP | 0.15 | 7.62 | 7.8 |
| Comparative | s-Me₂EDDP | 0.15 | 6.35 | 3.1 |
| Comparative | Silicate | 2.0 | 7.76 | 1.7 |
| Comparative | ″ | 1.0 | 6.51 | 1.6 |
| No Stabilizer | None | 0 | 3.48 | 1.6 |
| added | | | | |

The tests clearly show the surprisingly superior performance of the N^{α},N^{ω}-dialkyl aminomethylenephosphonic acids of the invention. For example, comparing the results of s-Me₂DTTP (compound of the present invention) with those of comparative compound u-Me₂DTTP, the importance of the N^{α},N^{ω}-dialkyl structure is clearly illustrated. The symmetrically N-methylated product shows a 3 point brightness advantage at ⅓ the dose level, and a 2 times advantage on peroxide stabilization at ⅓the dose level of the unsymmetrically N-methylated analog.

The necessity of at least 3 nitrogens is also illustrated. Comparative compounds EDTMP, u-Me₂EDDP, and s-Me₂EDDP are all based on ethylenediamine. While compound s-Me₂EDDP is symmetrically N-methylated, it does not perform to the high level of efficiency due to its insufficient structure. It is believed that the preferred N^{α},N^{ω}-dialkyl aminomethylenephosphonic acid structures of the invention are active due to their superior metal ion control and ability to form catalytically active metal complexes.

The invention s-Me₂DTTP N-oxide performs at least as well as the non-N oxide form. The claimed N-oxide structures II and III thus suffer no performance drop due to their N-oxide substitution.

In all cases, the compounds of the invention show an ability to out-perform the currently available products, even when applied at much lower dose rates. The lower amounts of stabilizer required makes the compounds of the invention more preferred from an environmental standpoint. The dramatically lower amounts of nitrogen (N) and phophorous (P) needed for adequate performance makes these products more attractive than the currently available products.

What is claimed is:

1. A peroxide bleaching composition comprising at least one N^{α},N^{ω}-dialkyl aminomethylenephosphonic acid having the following formula I 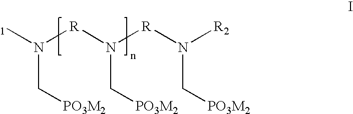
or N-oxide thereof having the following formula II or formula III 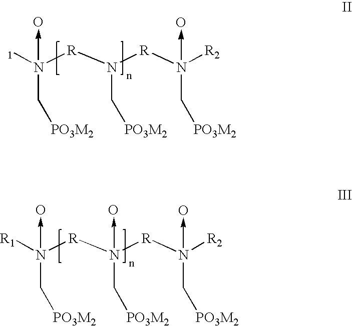
wherein R is an alkylene group having from 2 to 6 carbon atoms; R₁ and R₂ are each independently an alkyl group having from 1 to 6, preferably 1 to 4, carbon atoms, a hydroxyalkyl group having alkyl of from 1 to 6, preferably 1 to 4, carbon atoms, or carboxyalkyl group having alkyl of from 1 to 6, preferably from 1 to 4, carbon atoms; M is, independently in each occurrence, selected from the group consisting of H, NH₄, amine, alkali metal, alkaline earth metal, or a linear or branched alkyl group having from 1 to 4 carbon atoms; and n is an integer from 1 to 6.

2. The bleaching composition of claim 1 wherein in formulas I, II, and III R is an alkylene group having from 2 to 4 carbon atoms, R₁ and R₂ are each independently an alkyl group having from 1 to 4 carbon atoms, and M is, independently in each occurrence H, NH₄ or alkali metal.

3. The bleaching composition of claim 2 wherein R is ethylene, R₁ and R₂ are each independently methyl or ethyl, and M is H, NH₄ or sodium.

4. The bleaching composition of claim 3 comprising N,N″-dimethyl diethylenetriamine-N,N′N″-(trimethylene-phosphonic acid).

5. A composition for corrosion and scale inhibition or for the removal of scale employed in water treatment and oil field applications, said composition comprising at least one N^{α},N^{ω}-dialkyl aminomethylenephosphonic acid having the following formula I 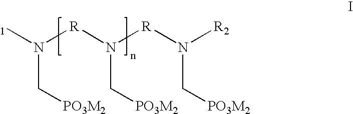
or N-oxide thereof having the following formula II or formula III 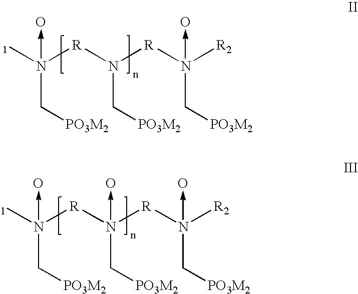
wherein R is an alkylene group having from 2 to 6 carbon atoms; R₁ and R₂ are each independently an alkyl group having from 1 to 6, preferably 1 to 4, carbon atoms, a hydroxyalkyl group having alkyl of from 1 to 6, preferably 1 to 4, carbon atoms, or carboxyalkyl group having alkyl of from 1 to 6, preferably from 1 to 4, carbon atoms; M is, independently in each occurrence, selected from the group consisting of H, NH₄, amine, alkali metal, alkaline earth metal, or a linear or branched alkyl group having from 1 to 4 carbon atoms; and n is an integer from 1 to 6.

6. The composition for corrosion and scale inhibition or scale removal of claim 5 wherein in formulas I, II, and III R is an alkylene group having from 2 to 4 carbon atoms, R₁ and R₂ are each independently an alkyl group having from 1 to 4 carbon atoms, and M is, independently in each occurrence H, NH₄ or alkali metal.

7. The composition for corrosion and scale inhibition or scale removal of claim 6 wherein R is ethylene, R₁ and R₂ are each independently methyl or ethyl, and M is H, NH₄ or sodium.

8. The composition for corrosion and scale inhibition or scale removal of claim 7 comprising N,N″-dimethyl diethylenetriamine-N,N′N″-(trimethylenephosphonic acid).

9. A detergent composition comprising at least one N^{α},N^{ω}-dialkyl aminomethylenephosphonic acid having the following formula I 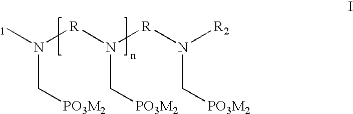
or N-oxide thereof having the following formula II or formula III 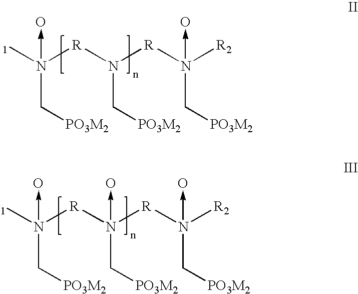
wherein R is an alkylene group having from 2 to 6 carbon atoms; R₁ and R₂ are each independently an alkyl group having from 1 to 6, preferably 1 to 4, carbon atoms, a hydroxyalkyl group having alkyl of from 1 to 6, preferably 1 to 4, carbon atoms, or carboxyalkyl group having alkyl of from 1 to 6, preferably from 1 to 4, carbon atoms; M is, independently in each occurrence, selected from the group consisting of H, NH₄, amine, alkali metal, alkaline earth metal, or a linear or branched alkyl group having from 1 to 4 carbon atoms; and n is an integer from 1 to 6.

10. The detergent composition of claim 9 wherein in formulas I, II, and III R is an alkylene group having from 2 to 4 carbon atoms, R₁ and R₂ are each independently an alkyl group having from 1 to 4 carbon atoms, and M is, independently in each occurrence H, NH₄ or alkali metal.

11. The detergent composition of claim 10 wherein R is ethylene, R₁ and R₂ are each independently methyl or ethyl, and M is H, NH₄ or sodium.

12. The detergent composition of claim 11 comprising N,N″-dimethyl diethylenetriamine-N,N′N″-(trimethylene-phosphonic acid).

13. An improved process for bleaching a cellulosic material which process comprises contacting the cellulosic material with a peroxide bleaching composition, the improvement comprising the use in the peroxide bleaching composition of at least one N^{α},N^{ω}-dialkyl aminomethylene-phosphonic acid having the following formula I 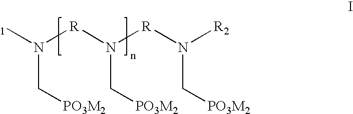
or N-oxide thereof having the following formula II or formula III 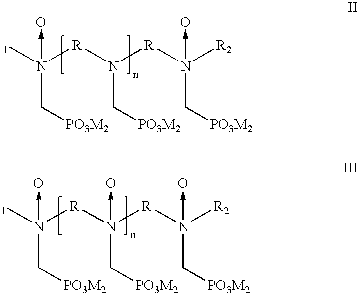
wherein R is an alkylene group having from 2 to 6 carbon atoms; R₁ and R₂ are each independently an alkyl group having from 1 to 6, preferably 1 to 4, carbon atoms, a hydroxyalkyl group having alkyl of from 1 to 6, preferably 1 to 4, carbon atoms, or carboxyalkyl group having alkyl of from 1 to 6, preferably from 1 to 4, carbon atoms; M is, independently in each occurrence, selected from the group consisting of H, NH₄, amine, alkali metal, alkaline earth metal, or a linear or branched alkyl group having from 1 to 4 carbon atoms; and n is an integer from 1 to 6; in an amount effective to stabilize a peroxide in said bleaching composition.

14. The process of claim 13 for bleaching a cellulosic material wherein in N^{α},N^{ω}-dialkyl aminomethylenephosphonic acid of formula I or in the corresponding N-oxide thereof of formula II or formula III R is an alkylene group having from 2 to 4 carbon atoms, R₁ and R₂ are each independently an alkyl group having from 1 to 4 carbon atoms, and M is, independently in each occurrence H, NH₄ or alkali metal.

15. The process of claim 14 for bleaching a cellulosic material wherein in N^{α},N^{ω}-dialkyl aminomethylenephosphonic acid of formula I or in the corresponding N-oxide thereof of formula II or formula III R is ethylene, R₁ and R₂ are each independently methyl or ethyl, and M is H, NH₄ or sodium.

16. The process of claim 15 for bleaching a cellulosic material wherein the N^{α},N^{ω}-dialkyl aminomethylenephosphonic acid is N,N″-dimethyl diethylenetriamine-N,N′N″-(trimethylenephosphonic acid).

17. An improved process for the inhibition of corrosion and scale deposits or for the removal of scale deposits in water treatment and oil field applications, the improvement comprising contacting corrosion and scale forming species or scale deposits with a composition comprising at least one N^{α},N^{ω}-dialkyl aminomethylenephosphonic acid having the following formula I 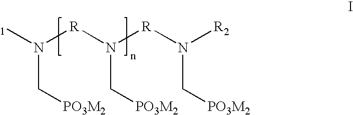
or N-oxide thereof having the following formula II or formula III 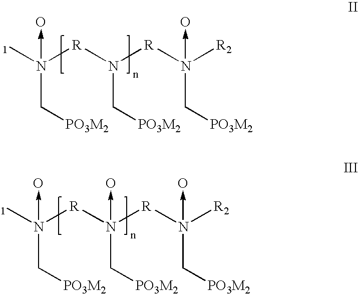
wherein R is an alkylene group having from 2 to 6 carbon atoms; R₁ and R₂ are each independently an alkyl group having from 1 to 6, preferably 1 to 4, carbon atoms, a hydroxyalkyl group having alkyl of from 1 to 6, preferably 1 to 4, carbon atoms, or carboxyalkyl group having alkyl of from 1 to 6, preferably from 1 to 4, carbon atoms; M is, independently in each occurrence, selected from the group consisting of H, NH₄, amine, alkali metal, alkaline earth metal, or a linear or branched alkyl group having from 1 to 4 carbon atoms; and n is an integer from 1 to 6; in an amount effective to inhibit corrosion and scale deposition or remove scale deposits.

18. The process of claim 17 for the inhibition of corrosion and scale or the removal of scale deposits in water treatment and oil field applications wherein in N^{α},N^{ω}-dialkyl aminomethylenephosphonic acid of formula I or in the corresponding N-oxide thereof of formula II or formula III R is an alkylene group having from 2 to 4 carbon atoms, R₁ and R₂ are each independently an alkyl group having from 1 to 4 carbon atoms, and M is, independently in each occurrence, H, NH₄ or alkali metal.

19. The process of claim 18 for the inhibition of corrosion and scale or the removal of scale deposits in water treatment and oil field applications wherein in N^{α},N^{ω}-dialkyl aminomethylenephosphonic acid of formula I or in the corresponding N-oxide thereof of formula II or formula III R is ethylene, R₁ and R₂ are each independently methyl or ethyl, and M is H, NH₄ or sodium.

20. The process of claim 19 for the inhibition of corrosion and scale or the removal of scale deposits in water treatment and oil field applications wherein the N^{α},N^{ω}-dialkyl aminomethylenephosphonic acid is N,N″-dimethyl diethylenetriamine-N,N′N″-(trimethylene-phosphonic acid).

21. A metal ion chelating composition comprising at least one N^{α},N^{ω}-dialkyl aminomethylenephosphonic acid having the following formula I 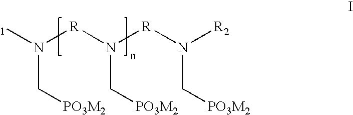
or N-oxide thereof having the following formula II or formula III 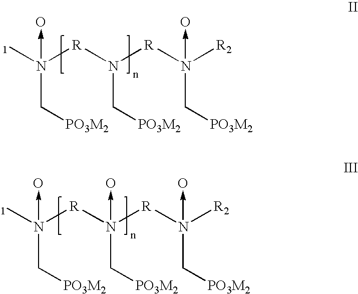
wherein R is an alkylene group having from 2 to 6 carbon atoms; R₁ and R₂ are each independently an alkyl group having from 1 to 6, preferably 1 to 4, carbon atoms, a hydroxyalkyl group having alkyl of from 1 to 6, preferably 1 to 4, carbon atoms, or carboxyalkyl group having alkyl of from 1 to 6, preferably from 1 to 4, carbon atoms; M is, independently in each occurrence, selected from the group consisting of H, NH₄, amine, alkali metal, alkaline earth metal, or a linear or branched alkyl group having from 1 to 4 carbon atoms; and n is an integer from 1 to 6.

22. The metal ion chelating composition of claim 21 wherein in formulas I, II, and III R is an alkylene group having from 2 to 4 carbon atoms, R₁ and R₂ are each independently an alkyl group having from 1 to 4 carbon atoms, and M is, independently in each occurrence H, NH₄ or alkali metal.

23. The metal ion chelating composition of claim 22 wherein R is ethylene, R₁ and R₂ are each independently methyl or ethyl, and M is H, NH₄ or sodium.

24. The metal ion chelating composition of claim 23 comprising N,N″-dimethyl diethylenetriamine-N,N′N″-(trimethylene-phosphonic acid).

25. A process for chelating a metal ion which process comprises contacting a metal ion with a composition comprising at least one N^{α},N^{ω}-dialkyl aminomethylenephosphonic acid having the following formula I 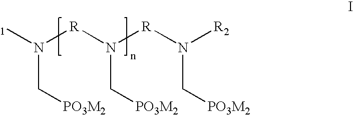
or N-oxide thereof having the following formula II or formula III 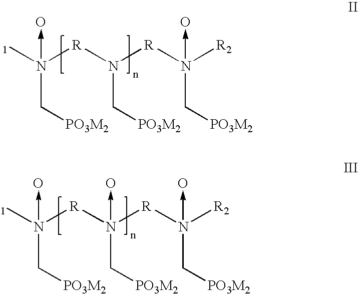
wherein R is an alkylene group having from 2 to 6 carbon atoms; R₁ and R₂ are each independently an alkyl group having from 1 to 6, preferably 1 to 4, carbon atoms, a hydroxyalkyl group having alkyl of from 1 to 6, preferably 1 to 4, carbon atoms, or carboxyalkyl group having alkyl of from 1 to 6, preferably from 1 to 4, carbon atoms; M is, independently in each occurrence, selected from the group consisting of H, NH₄, amine, alkali metal, alkaline earth metal, or a linear or branched alkyl group having from 1 to 4 carbon atoms; and n is an integer from 1 to 6; in an amount effective to chelate the metal ion.

26. The process of claim 25 for chelating a metal ion wherein in N^{α},N^{ω}-dialkyl aminomethylenephosphonic acid of formula I or in the corresponding N-oxide thereof of formula II or formula III R is an alkylene group having from 2 to 4 carbon atoms, R₁ and R₂ are each independently an alkyl group having from 1 to 4 carbon atoms, and M is, independently in each occurrence H, NH₄ or alkali metal.

27. The process of claim 26 for chelating a metal ion wherein in N^{α},N^{ω}-dialkyl aminomethylenephosphonic acid of formula I or in the corresponding N-oxide thereof of formula II or formula III R is ethylene, R₁ and R₂ are each independently methyl or ethyl, and M is H, NH₄ or sodium.

28. The process of claim 27 for chelating a metal ion wherein the N^{α},N^{ω}-dialkyl aminomethylenephosphonic acid is N,N″-dimethyl diethylenetriamine-N,N′N″-(trimethylenephosphonic acid).
